(19) United States
(12) Patent Application Publication
(10) Pub. No.: US 2025/0244694 A1
(43) Pub. Date: Jul. 31, 2025

(54) DEVELOPING ROLLER, DEVELOPING CARTRIDGE, PROCESS CARTRIDGE, AND ELECTROPHOTOGRAPHIC IMAGE FORMING APPARATUS

(71) Applicant: CANON KABUSHIKI KAISHA, Tokyo (JP)

(72) Inventors: ATSUSHI NOGUCHI, Shizuoka (JP); YOSHITAKA SUZUMURA, Shizuoka (JP); YUKI NASUNO, Shizuoka (JP); KAZUAKI NAGAOKA, Shizuoka (JP)

(21) Appl. No.: 19/039,297

(22) Filed: Jan. 28, 2025

(30) Foreign Application Priority Data
Jan. 29, 2024 (JP) 2024-010923

(51) Int. Cl. G03G 15/08; G03G 9/097; G03G 15/04; G03G 21/18

(52) U.S. Cl. CPC G03G 15/0818; G03G 9/09716; G03G 15/04; G03G 21/1814; G03G 2215/00974; G03G 2215/0402; G03G 2215/0617

(57) ABSTRACT

A developing roller having a conductive substrate and a resin layer present on the outer surface side of the substrate, wherein the developing roller is for a positive-charging toner, the resin layer contains a crosslinked urethane resin, an amino group is present at an outermost surface of the resin layer, where an ion intensity derived from the amino groups relative to all detected ions in the resin layer is 1.0% or more, a ratio of the total of detected values of Si, F, and Cl at the outermost surface of the resin layer is less than 5.0 Atomic %, and the elastic modulus and volume resistivity of the resin layer satisfy a specific relationship.

### BACKGROUND OF THE INVENTION

### Field of the Invention

The present disclosure relates to a developing roller, a developing cartridge, a process cartridge, and an electrophotographic image forming apparatus.

### Description of the Related Art

As the process speed of electrophotographic image forming apparatuses has been further increasing, a method of rapidly causing a toner to carry a charge by applying a high voltage to a toner layer thickness control member in contact with a developing roller and injecting an electric charge from the toner layer thickness control member is being considered.

Japanese Patent Application Publication 2006-243057 discloses a developing device (developing cartridge) having a toner layer thickness control member that triboelectrically charges positively-charging toner and a developing roller made of a urethane-based coating material. However, where such developing devices (developing cartridges) are used in electrophotographic image forming apparatuses with high process speeds, a problem that the charge quantity provided to the toner becomes distributed occurs in some cases.

In the present disclosure, the process cartridge means a cartridge which is configured of a drum cartridge and a developing cartridge that is detachably attached to the drum cartridge, and the developing cartridge means a cartridge which is configured of a developing unit mainly composed of a developing roller and a toner layer thickness control member, and a toner unit mainly composed of a toner storage unit.

### SUMMARY OF THE INVENTION

The inventors therefore considered adopting the developing roller according to Japanese Patent Application Publication 2006-243057 in an electrophotographic image forming device capable of applying a high voltage to a toner layer thickness control member (developing blade). However, when the toner on the developing roller according to Japanese Patent Application Publication 2006-243057 is caused to carry a charge by a toner layer thickness control member to which a high voltage is applied, triboelectric charging occurs in addition to injection charging, and there are cases where a distribution of the charge quantity provided to the toner occurs.

When the charge quantity provided to the toner is distributed, it may cause a decrease in image quality, known as “fogging,” in which the image density fluctuates or the toner is transferred to a solid white image on paper. In particular, as the process speed of an electrophotographic image forming apparatus increases, the occurrence of image density fluctuation and fogging becomes more pronounced.

At least one aspect of the present disclosure is directed to providing a developing roller that can suppress triboelectric charging of positive-charging toner and more reliably reduce leakage of charge of positive-charging toner to the developing roller in an electrophotographic image forming apparatus that applies a high voltage to a toner layer thickness control member.

Furthermore, at least one aspect of the present disclosure is directed to providing a developing cartridge that can provide high-quality electrophotographic images even in an electrophotographic image forming apparatus with a high process speed.

Furthermore, at least one aspect of the present disclosure is directed to providing a process cartridge that can provide high-quality electrophotographic images even in an electrophotographic image forming apparatus with a high process speed.

In addition, at least one aspect of the present disclosure is directed to providing an electrophotographic image forming apparatus capable of providing high-quality electrophotographic images even at a high process speed.

According to at least one aspect of the present disclosure, there is provided a developing roller having a conductive substrate and a resin layer present on the outer surface side of the substrate, wherein
the developing roller is for a positive-charging toner,
the resin layer comprises a crosslinked urethane resin,
an amino group is present at an outermost surface of the resin layer,
where the outermost surface of the resin layer is measured with a time-of-flight secondary ion mass spectrometer (TOF-SIMS), an ion intensity derived from the amino groups relative to all detected ions is 1.0% or more,
where the outermost surface of the resin layer is measured by an X-ray photoelectron spectroscopy (XPS), a ratio of the total of detected values of Si, F, and Cl based on the total of detected values of F, C, O, Si, N, and Cl is less than 5.0 Atomic %,
where an elastic modulus in a first region from the outermost surface of the resin layer to a depth of 0.1 μm is defined as E1, E1 is 200 MPa or more, and
a volume resistivity determined when a metal film is provided directly on the outermost surface of the developing roller and a DC voltage of 50 V is applied in an environment of a temperature of 23° C. and a relative humidity of 50% is 1.0×10⁶ Ω·cm or more.

In addition, according to at another aspect of the present disclosure, there is provided a developing cartridge having the above developing roller.

In addition, according to at another aspect of the present disclosure, there is provided a process cartridge having the above developing cartridge.

In addition, according to at another aspect of the present disclosure, there is provided an electrophotographic image forming apparatus having the above process cartridge.

Furthermore, according to at another aspect of the present disclosure, there is provided an electrophotographic image forming apparatus, the electrophotographic image forming apparatus comprising: an image-bearing member; a toner; a developing roller carrying the toner; a toner layer thickness control member that is in contact with the developing roller and that regulates a layer thickness of the toner carried on the developing roller and is capable of applying a predetermined voltage; an exposure device that exposes the image-bearing member to light to form an electrostatic latent image on the image-bearing member; a transfer device that transfers the toner image formed on the image-bearing member by a development of the electrostatic latent image onto the recording sheet; wherein the toner is a positive-charging toner having a positive-charging property and the developing roller is the developing roller according to above described.

According to at least one aspect of the present disclosure, there is provided a developing roller that can suppress triboelectric charging of positive-charging toner and more reliably reduce leakage of charge of positive-charging toner to the developing roller in an electrophotographic image forming apparatus that applies a high voltage to a toner layer thickness control member.

In addition, according to at least one aspect of the present disclosure, there is provided a developing cartridge that can provide high-quality electrophotographic images even in an electrophotographic image forming apparatus with a high process speed.

In addition, according to at least one aspect of the present disclosure, there is provided a process cartridge that can provide high-quality electrophotographic images even in an electrophotographic image forming apparatus with a high process speed.

Furthermore, according to at least one aspect of the present disclosure, there is provided an electrophotographic image forming apparatus capable of providing high-quality electrophotographic images even at a high process speed.

Further features of the present invention will become apparent from the following description of exemplary embodiments with reference to the attached drawings.

### BRIEF DESCRIPTION OF THE DRAWINGS

FIG. 1 is schematic cross-sectional view showing an example of a developing roller according to an embodiment of the present disclosure;

FIG. 2 is a schematic cross-sectional view showing another example of a developing roller according to an embodiment of the present disclosure;

FIG. 3 is a schematic diagram of an electrophotographic image forming apparatus;

FIG. 4 is a schematic diagram of a process cartridge;

FIG. 5 is a schematic diagram showing an example of an apparatus for measuring the electrical resistance of a developing roller; and

FIG. 6 is a cross-sectional view of a developing roller according to an embodiment of the present disclosure.

### DESCRIPTION OF THE EMBODIMENTS

Unless otherwise specified, descriptions of numerical ranges such as “from XX to YY” or “XX to YY” in the present disclosure include the numbers at the upper and lower limits of the range. When numerical ranges are described in stages, the upper and lower limits of each of each numerical range may be combined arbitrarily. In the present disclosure, wording such as “at least one selected from the group consisting of XX, YY and ZZ” means any of: XX; YY; ZZ; a combination of XX and YY; a combination of XX and ZZ; a combination of YY and ZZ; or a combination of XX and YY and ZZ.

The present inventors have speculated that the reason why a distribution of charge quantity provided to the toner occurs when the developing roller according to Japanese Patent Application Publication 2006-243057 is combined with a toner layer thickness control member to which a high voltage is applied is as follows.

The developing roller according to Japanese Patent Application Publication 2006-243057 uses a urethane-based coating material for the outermost layer. In addition, the positive-charging toner according to Japanese Patent Application Publication 2006-243057 uses silica with an amino group as an external additive. There is a difference in a triboelectric series between this developing roller and the positive-charging toner, and as a result, triboelectric charging occurs. Here, the triboelectric series (triboelectric list) refers to the order in which, when two types of materials are rubbed (slidingly contacted), the material that is easily charged to the positive polarity is placed higher in the series (positive polarity side) and the material that is easily charged to the negative polarity is placed lower in the series (negative polarity side). The charge imparted to the toner in this triboelectric charging is easily affected by the shape and particle diameter of the toner, which results in a distribution in the charge quantity of the toner. In addition, the charge injected into the toner leaks to the developing roller, which also causes the distribution in the charge quantity of the toner. That is, in order to obtain a sharper distribution of the charge quantity of the toner when the developing roller is combined with a toner layer thickness control member to which a high voltage is applied, it is necessary to reduce triboelectric charging as much as possible, maximize the charge injection from the toner layer thickness control member, and suppress charge leakage from the toner to the developing roller.

With this in mind, the inventors have conducted extensive research into developing rollers in which a resin layer contains crosslinked urethane resin, and have found that a developing roller that satisfies the following four requirements can solve the above-mentioned problems.
Requirement (1): the outermost surface of the resin layer of the developing roller has amino groups, and where the outermost surface is measured with a time-of-flight secondary ion mass spectrometer (TOF-SIMS), the ion intensity derived from the amino groups relative to all detected ions is 1.0% or more.
Requirement (2): where the outermost surface of the resin layer of the developing roller is measured by an X-ray photoelectron spectroscopy (XPS), the total amount of detected values of Si, F, and Cl is less than 5.0 Atomic % based on the total amount of all elements.
Requirement (3): where an elastic modulus in a first region from the outermost surface of the resin layer of the developing roller to a depth of 0.1 μm is defined as E1, E1≥200 MPa is satisfied.
Requirement (4): a volume resistivity determined when a metal film is provided directly on the outermost surface of the developing roller and a DC voltage of 50 V is applied in an environment of a temperature of 23° C. and a relative humidity of 50% is 1.0×10⁶ Ω·cm or more.

That is, the developing roller according to an embodiment of the present disclosure is a developing roller having a conductive substrate and a resin layer present on the outer surface side of the substrate, wherein
the developing roller is for a positive-charging toner,
the resin layer comprises a crosslinked urethane resin,
an amino group is present at an outermost surface of the resin layer,
where the outermost surface of the resin layer is measured with a time-of-flight secondary ion mass spectrometer (TOF-SIMS), an ion intensity derived from the amino groups relative to all detected ions is 1.0% or more,
where the outermost surface of the resin layer is measured by an X-ray photoelectron spectroscopy (XPS), a ratio of the total of detected values of Si, F, and Cl based on the total of detected values of F, C, O, Si, N, and Cl is less than 5.0 Atomic %, where an elastic modulus in a first region from the outermost surface of the resin layer to a depth of 0.1 μm is defined as E1, E1 is 200 MPa or more, and a volume resistivity determined when a metal film is provided directly on the outermost surface of the developing roller and a DC voltage of 50 V is applied in an environment of a temperature of 23° C. and a relative humidity of 50% is 1.0×10⁶ Ω·cm or more.

The following explains the above requirements (1) to (4) in detail.

### Regarding Requirement (1)

Requirement (1) specifies the amount of amino groups present at the outermost surface of the developing roller. This amount of amino groups is a value measured by a time-of-flight secondary ion mass spectrometer (TOF-SIMS). The presence of amino groups at the outermost surface of the developing roller can suppress triboelectric charging of positive-charging toner.

Positive-charging toner can be obtained by two methods, broadly divided into (a) using inorganic particles (for example, silica or titanium oxide) surface-treated with a treatment agent having an amino group as an external additive, and (b) using a material having an amino group as a toner particle. In either case, the presence of amino groups gives the toner positive charging performance.

The inventors have found that similarly, in the case of a developing roller, by having a certain amount of amino groups at the outermost surface of the developing roller, the triboelectric series difference with the positive-charging toner is eliminated, and triboelectric charging can be suppressed. Due to this effect, even in combination with a toner layer thickness control member to which a high voltage is applied, triboelectric charging can be suppressed and a charge can be imparted to the toner by injection charging.

When the outermost surface of the resin layer of the developing roller according to the present disclosure is measured with a time-of-flight secondary ion mass spectrometer (TOF-SIMS), the ion intensity derived from amino groups relative to all detected ions is 1.0% or more. The value of the ion intensity means the amount of amino groups present at the outermost surface of the developing roller. When the amount of amino groups at the outermost surface of the developing roller is 1.0% or more, triboelectric charging is suppressed, and a charge can be imparted to the toner by injection charging in combination with a toner layer thickness control member to which a high voltage is applied. As a result, distribution of the charge quantity of the toner is unlikely to occur, and deterioration of image quality can be suppressed. Where the amount of amino groups is less than 1.0%, functional groups other than amino groups (for example, alkyl chains derived from acrylic resin and the like) constituting the outermost surface of the developing roller become dominant in the triboelectric series, and triboelectric charging occurs with the positive-charging toner.

In the present disclosure, when the developing roller has a plurality of resin layers, the “resin layer” refers to the layer present on the outermost surface, unless otherwise specified.

The upper limit of the amount of amino groups is not particularly limited, but when introducing amino groups into the outermost surface of the developing roller by polymerization of (meth)acrylic monomers/oligomers having an amino group, as the amount of amino groups increases, the amount of acrylic component also increases. As a result, the hardness inside the developing roller (the elastic modulus E2 at a depth of from 1.0 μm to 1.1 μm from the outermost surface, which will be described hereinbelow) increases, so it is preferable that the amount of amino groups be less than 10.0%.

The amount of amino groups is preferably from 2.0% to 9.0%, and more preferably from 3.0% to 5.0%.

When introducing amino groups into the outermost surface of the developing roller by polymerization of a (meth)acrylic monomer or oligomer having an amino group, the amount of amino groups can be adjusted, as appropriate, by adjusting the number of parts of the amino group-containing (meth)acrylic monomer or oligomer added, adjusting the amount of amino groups present in the molecule of the (meth)acrylic monomer or oligomer, and the like.

### Regarding Requirement (2)

Requirement (2) specifies the total amount of Si, F, and Cl present at the outermost surface of the developing roller. This total amount of Si, F, and Cl is a value measured by X-ray photoelectron spectroscopy (XPS). As described above, a positive-charging toner has amino groups, and has the property of being positively charged due to the presence of the amino groups. In this positive-charging toner, where elements such as Si, F, and Cl are present at the outermost surface of the developing roller, the positive-charging toner will be negatively charged due to the triboelectric series difference between the positive-charging toner and the developing roller. For this reason, it is preferable that the outermost surface of the developing roller contain few elements such as Si, F, and Cl.

Where the outermost surface of the resin layer of the developing roller according to the present disclosure is measured by X-ray photoelectron spectroscopy (XPS), the Atomic % of the total of detected values of Si, F, and Cl is less than 5.0% based on the total amount of all elements. By keeping this amount less than 5.0%, it is possible to suppress the positive-charging toner from being negatively charged, and to suppress the occurrence of a distribution in the charge quantity of the toner.

Si, F, and Cl are used as additives and surfactants in surface layer coating materials and are mainly derived from dispersing agents for carbon black, which is a conductive filler. The lower limit of the Atomic % of the total of detected values of Si, F, and Cl is not particularly limited, but from the viewpoint of the dispersibility of carbon black and the uniformity of conductivity in the resin layer, the Atomic % of the total of detected values of Si, F, and Cl is preferably from 0.0% to 4.0%, more preferably from 0.0% to 1.0%, even more preferably from 0.1% to 1.0%, and still more preferably from 0.2% to 1.0%.

The Atomic % of the total of detected values of Si, F, and Cl can be adjusted, as appropriate, by adjusting the raw material composition used for the resin layer, specifically, by adjusting the number of parts of the additive containing Si, F, and Cl added, or by adjusting the amount of Si, F, and Cl groups present in the molecule of the additive containing Si, F, and Cl.

### Regarding Requirement (3)

Requirement (3) specifies the elastic modulus in a region (first region) from the outermost surface of the developing roller to a depth of 0.1 μm. A high elastic modulus in this region indicates that the hardness of the outermost surface of the developing roller is high. Where the hardness of the outermost surface of the developing roller is high, the contact area with the toner is reduced. It is known that the contact area between the toner and the developing roller is positively correlated with the triboelectric charge quantity of the toner. In other words, the reduction in the contact area between the toner and the developing roller can suppress triboelectric charging of the toner.

Where the elastic modulus in the region from the outermost surface of the developing roller to a depth of 0.1 μm is defined as E1, the developing roller according to the present disclosure has an E1 of 200 MPa or more, so that the contact area between the toner and the developing roller is sufficiently small and triboelectric charging of the toner can be suppressed.

The upper limit of E1 is not particularly limited, but from the viewpoint of suppressing the pressure applied to the contact point with the toner and preventing fusion even when a soft toner is used, it is preferable that E1 be 900 MPa or less, and more preferably 500 MPa or less.

For the above reasons, E1 is preferably from 300 MPa to 900 MPa, and more preferably from 350 MPa to 500 MPa.

In addition, where the elastic modulus in the region (second region) at a depth of from 1.0 μm to 1.1 μm from the outermost surface of the developing roller is defined as E2, it is preferable that E2 be from 1 MPa to 100 MPa. E2 is more preferably from 10 MPa to 80 MPa, and even more preferably from 20 MPa to 60 MPa. When E2 is within the above-mentioned ranges, the load from the developing roller to the toner is reduced, and scratches and deterioration of the toner in durability evaluation can be suppressed. In the developing roller according to the present disclosure, it is more preferable that E1 and E2 each simultaneously satisfy the above-mentioned preferable numerical ranges. By simultaneously satisfying the preferable numerical ranges of E1 and E2, it is possible to increase the hardness of only the outermost surface without increasing the load on the toner, and therefore the contact area between the toner and the developing roller can be narrowed. As a method for increasing the elastic modulus E1, it is preferable to form an IPN structure described hereinbelow in the resin layer. This structure can selectively increase E1 without increasing E2.

As a method for increasing hardness, for example, a method of significantly increasing the crosslink density of the resin layer that constitutes the outermost surface of the developing roller can be cited, but such a method results in high hardness even inside the resin layer. This increases the load on the toner, and the toner deteriorates in durability evaluations. In addition, when increasing strength using such a method, flexibility may decrease and the toner may become brittle, which may worsen scratches due to scraping.

### Regarding Requirement (4)

Requirement (4) specifies the volume resistivity of the developing roller. This volume resistivity is a physical property value that indicates the charge leakage from the toner to the developing roller. In an electrophotographic image forming apparatus in which a high voltage is applied to a toner layer thickness control member that is in contact with the developing roller, and the toner is charged by injection of charge from the toner layer thickness control member, a large voltage is applied to the toner layer thickness control member. Therefore, in the area where the toner layer thickness control member and the developing roller contact each other with the toner interposed therebetween, a force is applied to the toner that presses the toner toward the developing roller. In this case, where the volume resistivity of the developing roller is low, the charge of the toner will leak to the developing roller.

In the developing roller according to the present disclosure, where a volume resistivity determined when a metal film is provided directly on the outermost surface of the developing roller and a DC voltage of 50 V is applied in an environment of a temperature of 23° C. and a relative humidity of 50% is 1.0×10⁶ Ω·cm or more, charge leakage from the toner to the developing roller can be suppressed even when a high voltage is applied to the toner layer thickness control member, the distribution of the charge quantity of the toner can be suppressed, and as a result, deterioration of image quality can be suppressed.

The upper limit of the volume resistivity is not particularly limited, but if it is 1.0×10⁹ Ω·cm or less, excessive charging of the toner can be suppressed, and a decrease in image density and fogging can be easily suppressed.

The volume resistivity is preferably from 1.0×10⁷ Ω·cm to 1.0×10⁹ Ω·cm, and more preferably from 1.0×10⁸ Ω·cm to 5.0×10⁸ Ω·cm.

The volume resistivity can be adjusted, as appropriate, by adjusting the number of added parts of the conductive filler contained in the resin layer, or by controlling the volume resistivity by adjusting the composition of the binder resin forming the resin layer. Specifically, the volume resistivity can be increased by lowering the content of the conductive filler.

Hereinafter, one embodiment of the present disclosure will be described using the drawings, but the present disclosure is not limited to the configuration shown below.

### Developing Roller

The developing roller according to at least one aspect of the present disclosure has a conductive substrate and a resin layer on the outer peripheral surface side of the substrate.

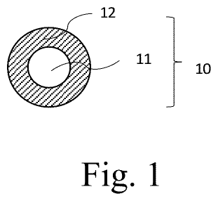

An example of a developing roller is shown in FIG. 1. A developing roller 10 shown in FIG. 1 has a resin layer 12 laminated on the outer surface, which is the outer peripheral surface of a columnar or hollow cylindrical substrate 11.

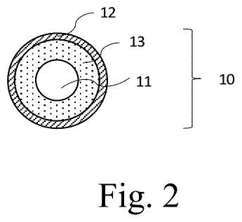

The layer configuration of the developing roller is not limited to the form shown in FIG. 1. Another layer may be provided between the substrate 11 and the resin layer 12. As another form of the developing roller, as shown in FIG. 2, a developing roller having an elastic layer 13 as an intermediate layer between the substrate 11 and the resin layer 12 provided on the outer peripheral surface thereof can be mentioned. The resin layer 12 is, for example, a surface layer. It is preferable that the resin layer 12 form the outermost surface of the electrophotographic roller.

The elastic layer is not particularly limited, and any known elastic layer for a developing roller may be used.

### Substrate

The substrate has a conductive outer surface and functions as a support member for the developing roller, and in some cases as an electrode. Specific examples of the substrate are preferably solid columnar or hollow cylindrical substrates.

The material constituting the substrate may be selected, as appropriate, from those known in the field of conductive members for electrophotography and materials usable as the developing roller. Examples include metals and alloys such as aluminum, iron, stainless steel, copper alloys, and carbon steel, and synthetic resins having conductivity. Furthermore, the material constituting the substrate may be subjected to an oxidation treatment, or a plating treatment with chromium, nickel, or the like. As the type of plating, either electroplating or electroless plating can be used, but electroless plating is preferable from the viewpoint of dimensional stability. Examples of the electroless plating that can be used here include nickel plating, copper plating, gold plating, and various other types of alloy plating. The plating thickness is preferably 0.05 μm or more, and considering the balance between work efficiency and rust prevention ability, the plating thickness is preferably from 0.1 μm to 30 μm.

A primer may be applied to the surface of the substrate to improve adhesion between the substrate and the resin layer. A known primer can be selected and used depending on the rubber material for forming the conductive layer, the material of a support, and the like. Examples of primer materials include thermosetting resins and thermoplastic resins, and specifically, at least one selected from the group consisting of phenolic resins, polyurethanes, acrylic resins, polyester resins, polyether resins, and epoxy resins can be used.

### Resin Layer

### Binder Resin

The resin layer in the present disclosure includes a crosslinked urethane resin. Furthermore, the resin layer in the present disclosure preferably has a matrix containing a crosslinked urethane resin as a binder. Crosslinked urethane resins are suitable as binder resins because they have excellent flexibility and strength and can form an interpenetrating polymer network structure (hereinafter referred to as an IPN structure) described below. An IPN structure is defined as a structure in which the network structures of two or more polymer compounds are intertwined and entangled with each other without being bonded by covalent bonds.

Urethane resins can be obtained from urethane raw materials containing polyols, isocyanates, and, if necessary, chain extenders. The urethane resins may be cured products of the urethane raw materials, or may be cured products of urethane raw material mixtures containing the urethane raw materials and additives such as surface modifiers and roughness-forming particles. As the polyol, which is the raw material for urethane resins, polyols known for urethane resin synthesis or polyols that can be used for urethane resin synthesis can be used. Examples of polyol compounds include the following. Polycarbonate polyols, polyether polyols, polyester polyols, polyolefin polyols such as polybutadiene polyols and polyisoprene polyols, so-called polymer polyols obtained by polymerizing ethylenically unsaturated monomers in polyols, polyester polycarbonate copolymer polyols, and the like.

Among these, polycarbonate polyols and polyester polycarbonate copolymer polyols are preferred.

Examples of polycarbonate polyols include the following: polynonamethylene carbonate diol, poly(2-methyl-octamethylene) carbonate diol, polyhexamethylene carbonate diol, polypentamethylene carbonate diol, poly(3-methylpentamethylene) carbonate diol, polytetramethylene carbonate diol, polytrimethylene carbonate diol, poly(1,4-cyclohexanedimethylene carbonate) diol, poly(2-ethyl-2-butyl-trimethylene) carbonate diol, and random/block copolymers thereof.

Examples of polyester polycarbonate copolymer polyols include the following. Copolymers obtained by polycondensation of lactones such as ε-caprolactone with the above polycarbonate polyols, and copolymers of polyesters obtained by polycondensation of diols such as 1,4-butanediol, 1,5-pentanediol, 1,6-hexanediol, 3-methylpentanediol, and neopentyl glycol with dicarboxylic acids such as adipic acid and sebacic acid.

Examples of isocyanates, which are raw materials for urethane resins, include the following substances.

At least one selected from the group consisting of tolylene diisocyanate (TDI), diphenylmethane diisocyanate (MDI), naphthalene diisocyanate (NDI), tolidine diisocyanate (TODI), hexamethylene diisocyanate (HDI), isophorone diisocyanate (IPDI), phenylene diisocyanate (PPDI), xylylene diisocyanate (XDI), tetramethylxylylene diisocyanate (TMXDI), cyclohexane diisocyanate, polymeric MDI, and mixtures thereof. Examples of chain extenders, which are raw materials for urethane resins, include at least one selected from the group consisting of bifunctional low-molecular-weight diols such as ethylene glycol, 1,4-butanediol, and 3-methylpentanediol, trifunctional low-molecular-weight triols such as trimethylolpropane, and mixtures thereof.

Among the above, polymeric MDI is preferred. Here, polymeric MDI is a mixture of monomeric MDI and a high-molecular-weight polyisocyanate, and is represented by a following formula (A). In formula (A), n is preferably from 0 to 4.

As the polymeric MDI, commercially available products may be used, such as Millionate MR400 (product name) and the Millionate MR series (manufactured by Tosoh Corporation).

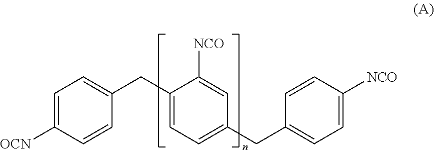

As chain extenders, which are raw materials for urethane resins, bifunctional low-molecular-weight diols such as ethylene glycol, 1,4-butanediol, and 3-methylpentanediol, trifunctional low-molecular-weight triols such as trimethylolpropane, and mixtures thereof may be used.

In addition, prepolymer type isocyanate compounds having isocyanate groups at the terminals may be used, which are obtained by reacting the above-mentioned various isocyanate compounds with various polyols in advance in a state where the isocyanate groups are in excess. In addition, as these isocyanate compounds, materials in which the isocyanate group is blocked with various blocking agents such as 2-butanone oxime (MEK oxime) may be used. Whatever material is used, a urethane resin can be obtained by reacting a polyol with an isocyanate by heating. Furthermore, if either or both of the polyol and isocyanate have a branched structure and have three or more functional groups, the resulting urethane resin becomes a crosslinked urethane resin.

The ratio of the number of isocyanate groups to the number of hydroxyl groups in the urethane resin (hereinafter also referred to as the “NCO/OH ratio”) is preferably from 1.0 to 2.0. Where this NCO/OH ratio is from 1.0 to 2.0, the crosslinking reaction proceeds, and the so-called “bleeding” of unreacted components and low molecular weight polyurethane is easily suppressed. The NCO/OH ratio is more preferably from 1.0 to 1.6. Where the NCO/OH ratio is from 1.0 to 1.6, the bleeding is suppressed and the hardness of the polymer is easily suppressed.

### Crosslinked Acrylic Resin

The resin layer in the present disclosure preferably contains a crosslinked acrylic resin. Furthermore, it is preferable that the crosslinked urethane resin and the crosslinked acrylic resin form an IPN structure. The IPN structure in the resin layer according to this embodiment is preferably formed by the crosslinked acrylic resin penetrating into the network of the three-dimensional crosslinked structure of the crosslinked urethane resin.

The crosslinked acrylic resin is harder than the crosslinked urethane resin, so it is possible to increase the hardness of the outermost surface of the resin layer, but the crosslinked acrylic resin alone is insulating, so the surface potential may become extremely high. In addition, the crosslinked acrylic resin is brittle, so it is easily scraped by rubbing and scratches are easily caused. Meanwhile, in the case of an IPN structure in which the crosslinked acrylic resin penetrates into the network of the three-dimensional crosslinked structure of the crosslinked urethane resin in the very vicinity of the outermost surface of the resin layer, hardness and brittleness are unlikely to be demonstrated, and high strength can be imparted while maintaining flexibility.

Furthermore, in order to suppress triboelectric charging of the positive-charging toner, the crosslinked acrylic resin of the present disclosure is preferably formed by polymerization of a (meth)acrylic monomer or oligomer having an amino group. The amino group may be any of primary, secondary, and tertiary. The type of (meth)acrylic monomer or oligomer used herein includes a polyfunctional monomer or oligomer having a plurality of acryloyl groups or methacryloyl groups as functional groups in order to form a crosslinked structure. The polymerization method of the (meth)acrylic monomer is not particularly limited, and a known method can be used. Specifically, methods such as heating and ultraviolet irradiation can be mentioned. For each polymerization method, a known radical polymerization initiator or ionic polymerization initiator can be used. These polymerization initiators may be used alone or in combination of two or more types.

The content of the crosslinked acrylic resin in the resin layer relative to 100 parts by mass of the crosslinked urethane resin is preferably from 1.0 part by mass to 5.0 parts by mass, and more preferably from 3.0 parts by mass to 5.0 parts by mass.

The thickness of the resin layer is, for example, from 3 μm to 50 μm, preferably from 5 μm to 30 μm, and more preferably from 10 μm to 20 μm.

Known heating devices and ultraviolet ray irradiation devices can be used as appropriate. Examples of light sources that can be used to irradiate with ultraviolet rays include LED lamps, high-pressure mercury lamps, metal halide lamps, xenon lamps, and low-pressure mercury lamps. The accumulated light quantity required for polymerization can be adjusted, as appropriate, depending on the type and amount of the compound and polymerization initiator used.

There are several methods for forming an IPN structure. For example, there is a sequential network formation method in which a network of the first component polymer is initially formed, the second component monomers and polymerization initiators are thereafter used to swell the network, and then a network of the second component polymer is formed, and a simultaneous network formation method in which first component monomers, second component monomers, and respective polymerization initiators that have different reaction mechanisms are mixed, and a network is formed at the same time.

When the crosslinked acrylic resin has an amino group, it is preferable to use the sequential network formation method in order to form an IPN structure between the crosslinked acrylic resin having an amino group and the crosslinked urethane resin in the vicinity of the outermost surface of the resin layer. In the simultaneous network formation method, the (meth)acrylic monomer having an amino group, which is the raw material of the acrylic resin, and the isocyanate and polyol, which are the raw materials of the urethane resin, are mixed simultaneously into the coating material. When mixed simultaneously, the (meth)acrylic monomer having an amino group has high compatibility with the isocyanate and polyol, so that when the resin layer of the developing roller is formed by polymerization, the amino groups are uniformly present throughout the resin layer.

Therefore, for a certain amount or more of amino groups to be present at the outermost surface of the resin layer, it is necessary to increase the amount of the (meth)acrylic monomer having an amino group. However, where the amount of the (meth)acrylic monomer having an amino group is increased, the hardness (elastic modulus E2) inside the resin layer increases. When the hardness inside the resin layer increases, the load on the toner increases over durability, causing deformation and cracking of the toner, resulting in image defects such as fogging and fluctuations in image density. For this reason, it is preferable to use the sequential network formation method rather than the simultaneous network formation method.

The type of (meth)acrylic monomer used here includes a polyfunctional monomer having a plurality of acryloyl or methacryloyl groups as functional groups in order to form a crosslinked structure. As the (meth)acrylic monomer used for the crosslinked acrylic resin, it is preferable to use a bifunctional (meth)acrylic monomer or a trifunctional (meth)acrylic monomer, and it is preferable to use these in combination.

The bifunctional (meth)acrylic monomer is preferably at least one selected from the group consisting of alkylene glycol di(meth)acrylates and alkylene oxide (ethylene oxide, propylene oxide) modified products of alkylene glycol di(meth)acrylates. For example, propylene oxide-modified neopentyl glycol diacrylate can be mentioned.

Examples of trifunctional (meth)acrylic monomers include trimethylolpropane tri(meth)acrylate and pentaerythritol tri(meth)acrylate.

The molecular weight of the (meth)acrylic monomer or oligomer is preferably in the range of from 200 to 750. By using a molecular weight in this range, an IPN structure can be easily formed with respect to the network structure of the crosslinked urethane resin, and the strength of the resin layer can be effectively improved.

As mentioned above, the (meth)acrylic monomer is impregnated into the resin layer containing the crosslinked urethane resin. For this purpose, it is necessary for the monomer to have an adequate viscosity. That is, where the viscosity is high, impregnation is difficult, and where the viscosity is low, it may be difficult to control the impregnation state. Therefore, the viscosity of the (meth)acrylic monomer is preferably from 5.0 mPa·s to 140 mPa·s at 25° C.

### Resin Particles

Resin particles may be added to the resin layer in order to form protruded portions on the surface of the developing roller. When surface roughness is to be imparted to the resin layer, fine particles for imparting the roughness to the resin layer may be included. Specifically, fine particles of at least one type of resin selected from the group consisting of polyurethane resins, polyester resins, polyether resins, polyamide resins, acrylic resins, and polycarbonate resins may be used. These are also preferably crosslinked resin particles. When an IPN structure is formed at the outermost surface side of the resin layer, an IPN structure may also be formed inside the crosslinked resin particles. The volume-average particle diameter of the fine particles is preferably from 1.0 μm to 30 μm, and the surface roughness (ten-point average roughness) Rzjis formed by the fine particles is preferably from 0.1 μm to 20 μm. Rzjis is a value measured based on JIS B 0601 (1994). The content of the resin particles is, for example, from 1 part by mass to 25 parts by mass, preferably from 5 parts by mass to 15 parts by mass per 100 parts by mass of the resin component forming the resin layer.

### Conductive Filler

The resin layer may contain a conductive filler. Examples of conductive fillers include: carbon-based substances such as carbon black and graphite; metals or alloys such as aluminum, silver, gold, tin-lead alloy, and copper-nickel alloy; metal oxides such as zinc oxide, titanium oxide, aluminum oxide, tin oxide, antimony oxide, indium oxide, and silver oxide; and substances in which various fillers are plated with conductive metals such as copper, nickel, and silver. Carbon black is particularly preferably used as a conductive filler because it is inexpensive, and conductivity can be easily controlled. Among them, those that have a relatively small primary particle diameter and maintain a hydrophobic tendency are particularly preferably used because they have good uniform dispersion in the resin layer.

In consideration of the reinforcing performance and electrical conductivity of the resin layer, the primary particle diameter of the carbon black is preferably in the range of from 20 nm to 60 nm in terms of the number-average primary particle diameter. As for the surface characteristics of the carbon black, it is preferable that the pH at 20° C. be from 3.0 to 8.0. Furthermore, the content of the carbon black is preferably from 5.0 parts by mass to 45.0 parts by mass, and more preferably from 20.0 parts by mass to 30.0 parts by mass per 100 parts by mass of the resin component forming the resin layer.

### Other Additives

In addition to those described hereinabove, the resin layer may contain various additives such as crosslinking agents, crosslinking assistants, plasticizers, filling agents, extenders, vulcanizing agents, vulcanization assistants, antioxidants, antiaging agents, processing assistants, dispersants, and leveling agents, provided that these do not impair the above functions.

In the present disclosure, when other additives are contained, it is preferable to select those that do not cause the amino groups to disappear by reaction. Furthermore, when additives containing elements such as Si, F, and Cl are used, it is necessary to adjust the amount of additives added so that the ratio of the total of detection values of Si, F, and Cl based on the total of detection values of F, C, O, Si, N, and Cl be less than 5.0 Atomic % when the outermost surface of the resin layer of the developing roller is measured by X-ray photoelectron spectroscopy (XPS).

### Intermediate Layer (Elastic Layer)

The developing roller may have an elastic layer as the intermediate layer 13 on the outermost surface of the substrate. The developing roller may have an elastic layer, for example, between the substrate and the resin layer. There are no particular limitations on the elastic layer, and any layer known as an elastic layer for a developing roller may be used. For example, a cured product of an addition-curable liquid silicone rubber mixture may be used. The thickness of the intermediate layer may be, for example, from 1.0 mm to 10.0 mm, or from 2.0 mm to 5.0 mm.

The addition-curable liquid silicone rubber may be a known one, such as a liquid dimethylpolysiloxane having two or more silicon atom-bonded alkenyl groups in one molecule, or a liquid dimethylpolysiloxane having two or more silicon atom-bonded hydrogen atoms in one molecule. A filler such as carbon black may also be used in the addition-curable liquid silicone rubber mixture.

### Method for Producing Resin Layer

A method for producing a developing roller preferably includes a step of preparing a conductive substrate, and a step of forming a resin layer on the outer surface side of the substrate. The step of forming a resin layer preferably includes a step of applying and curing a urethane raw material mixture containing a urethane raw material that forms a crosslinked urethane resin and a surface modifier to obtain a crosslinked urethane resin. Furthermore, it is preferable to obtain a resin layer by impregnating the crosslinked urethane resin with a (meth)acrylic monomer that will form a crosslinked acrylic resin, and polymerizing the surface modifier and the (meth)acrylic monomer to form a crosslinked acrylic resin.

The surface modifier is preferably a (meth)acrylate monomer and/or oligomer having a silicone group and/or a fluorine group in the molecule. The weight-average molecular weight Mw of the surface modifier is preferably from 200 to 3000.

Before the step of forming the resin layer, a step of forming an elastic layer on the outer surface of the substrate may be performed. The elastic layer can be obtained, for example, by applying a silicone rubber mixture to the outer surface of the substrate and curing.

A method of forming the resin layer containing the crosslinked urethane resin is not particularly limited, but a coating molding method using a liquid coating material is preferable. For example, it is preferable to disperse and mix each material for the resin layer as a urethane raw material mixture in a solvent to form a coating material, which is then coated on a conductive substrate and dried and solidified or heated and cured.

The solvent is preferably a polar solvent from the viewpoint of compatibility with polyols and isocyanate compounds, which are the raw materials for the crosslinked urethane resin. Examples of polar solvents include alcohols such as methanol, ethanol, and 1-propanol, ketones such as acetone, 2-butanone (methyl ethyl ketone), and 4-methyl-2-pentanone (methyl isobutyl ketone), and esters such as methyl acetate and ethyl acetate. Among these, one or more solvents that are compatible with other materials can be used in combination.

The solid content when making the coating material can be freely adjusted by the amount of solvent mixed, but from the viewpoint of uniformly dispersing the electronically conductive material such as carbon black, the solid content is preferably from 20.0% by mass to 40.0% by mass. For dispersion and mixing, known dispersion devices using beads, such as a sand mill, a coating material shaker, a dyno mill, and a pearl mill can be used. For coating, dip coating, ring coating, spray coating, or roll coating can be used.

As an example of a specific procedure, first, a polyol and an isocyanate-based compound, which are the raw materials of the binder resin, a conductive filler, an additive, etc. are mixed to obtain a liquid coating material. After that, the resin layer coating material is coated on the above-mentioned substrate. After that, a resin layer of crosslinked urethane resin is formed by drying and solidifying or by heating and curing.

Next, the formed resin layer is impregnated with a liquid (meth)acrylic monomer or oligomer having an amino group. As a method for impregnation, a liquid (meth)acrylic monomer or oligomer having an amino group can be impregnated as it is, or as an impregnation treatment liquid obtained by diluting, as appropriate, with various solvents. By diluting, as appropriate, the liquid (meth)acrylic monomer having an amino group with various solvents, a resin layer with a more uniform surface composition can be obtained. The solvent can be freely selected as long as it satisfies both the affinity with the resin layer and the solubility of the liquid (meth)acrylic monomer having an amino group. Examples of the impregnation liquid include alcohols such as methanol, ethanol, and 1-propanol, ketones such as acetone, 2-butanone (methyl ethyl ketone), and 4-methyl-2-pentanone (methyl isobutyl ketone), and esters such as methyl acetate and ethyl acetate. In addition, a polymerization initiator is mixed, as appropriate, into the impregnation liquid. Details of the polymerization initiator are as described above. The impregnation method with the impregnation liquid is not particularly limited, and dip coating, ring coating, spray coating, or roll coating can be used.

After the impregnation treatment with the impregnation liquid is thus performed, the (meth)acrylic monomer or oligomer having an amino group is polymerized and cured to form an IPN structure in which the crosslinked urethane resin and the acrylic resin having amino groups are mutually entangled. The polymerization and curing methods are not particularly limited, and known methods can be used. Specifically, methods such as heat curing and ultraviolet irradiation can be used.

### Positive-Charging Toner

The positive-charging toner according to the present disclosure will be described hereinbelow.

The positive-charging toner of the present disclosure preferably contains a toner particle and an external additive, and the toner particle is preferably a particle containing a binder resin, a colorant, and a charge control agent. The toner particle may contain, as necessary, other additives such as a release agent and a pigment dispersing agent.

Specific examples of the binder resin include resins that have been widely used in toners, such as polystyrene, styrene-butyl acrylate copolymer, polyester resins, and epoxy resins.

A method for producing a toner particle is exemplified by, but is not limited to, a pulverization method and a polymerization method. Toners obtained by these methods are called pulverized toner and polymerized toner, respectively. Polymerized toner is preferred as the toner because it has a relatively small particle diameter distribution on the order of microns. Examples of the polymerization method include emulsion polymerization aggregation method, dispersion polymerization method, and suspension polymerization method, with suspension polymerization method being preferred.

When toner particles are produced by using a polymerization method, for example, the following process can be used. First, a polymerizable monomer, a colorant, a charge control agent, and other additives as necessary are mixed to obtain a polymerizable monomer composition. This polymerizable monomer composition is placed in an aqueous medium containing, as necessary, a dispersion stabilizer, and then a polymerization initiator is added and granulation is performed. Then, polymerization is performed to obtain an aqueous dispersion of toner particles. This aqueous dispersion is washed, dehydrated, and dried to obtain dried toner particles. These dried toner particles are classified, as necessary, and external additives and, further, a carrier are added, as necessary, to obtain a polymerized toner.

### Polymerizable Monomer Composition

A polymerizable monomer refers to a compound that can be polymerized.

It is preferable to use a monovinyl monomer as the main component of the polymerizable monomer. Examples of monovinyl monomers include styrene; styrene derivatives such as vinyl toluene and α-methyl styrene; acrylic acid and methacrylic acid; acrylic acid esters such as methyl acrylate, ethyl acrylate, propyl acrylate, butyl acrylate, 2-ethylhexyl acrylate, and dimethylaminoethyl acrylate; methacrylic acid esters such as methyl methacrylate, ethyl methacrylate, propyl methacrylate, butyl methacrylate, 2-ethylhexyl methacrylate, and dimethylaminoethyl methacrylate; acrylic acid derivatives and methacrylic acid derivatives such as acrylonitrile, methacrylonitrile, acrylamides, and methacrylamides; olefins, such as ethylene, propylene, and butylene; vinyl halides and vinylidene halides, such as vinyl chloride, vinylidene chloride, and vinyl fluoride; vinyl esters such as vinyl acetate and vinyl propionate; vinyl ethers such as vinyl methyl ether and vinyl ethyl ether; vinyl ketones such as vinyl methyl ketone and methyl isopropenyl ketone; and nitrogen-containing vinyl compounds, such as 2-vinyl pyridine, 4-vinyl pyridine, and N-vinyl pyrrolidone. These monovinyl monomers may be used alone or in combination. Of these, styrene, styrene derivatives, and derivatives of acrylic acid or methacrylic acid are preferably used as the monovinyl monomer.

### Colorant

A colorant is used in the toner particles according to the present disclosure, and when producing a color toner, black, cyan, yellow, and magenta colorants can be used.

As for the colorants, the following colorants or dyes can be used as black colorants: carbon black, titanium black, magnetic powders such as zinc iron oxide and nickel iron oxide, oil black, and titanium white. Carbon black of black color with a primary particle diameter of from 20 nm to 40 nm is preferably used. A particle diameter in this range is preferable because the carbon black can be uniformly dispersed in the toner and fogging is reduced.

As cyan colorants, for example, copper phthalocyanine compounds, derivatives thereof, anthraquinone compounds, and the like can be used. Specific examples include C. I. Pigment Blue 2, 3, 6, 15, 15:1, 15:2, 15:3, 15:4, 16, 17:1, and 60, and copper phthalocyanines such as C. I. Pigment Blue 15, 15:1, 15:2, 15:3, 15:4, and 17:1 are preferred, as they have good polymerization stability and tinting strength, with 15:3 being even more preferred.

For example, compounds such as azo pigments such as monoazo pigments and diazo pigments, and condensed polycyclic pigments can be used as yellow colorants. Specific examples include C. I. Pigment Yellow 3, 12, 13, 14, 15, 17, 62, 65, 73, 74, 83, 93, 97, 120, 138, 155, 180, 181, 185, and 186. Monoazo pigments such as C. I. Pigment Yellow 3, 15, 65, 73, 74, 97, and 120 are preferred, as they have good polymerization stability and tinting strength, with C. I. Pigment Yellow 74 being even more preferred.

For example, compounds such as azo pigments such as monoazo pigments and diazo pigments, and condensed polycyclic pigments can be used as magenta colorants. Specific examples include C. I. Pigment Red 31, 48, 57:1, 58, 60, 63, 64, 68, 81, 83, 87, 88, 89, 90, 112, 114, 122, 123, 144, 146, 149, 150, 163, 170, 184, 185, 187, 202, 206, 207, 209, and 251, and C. I. Pigment Violet 19. Similarly, monoazo pigments such as C. I. Pigment Red 31, 48, 57:1, 58, 60, 63, 64, 68, 112, 114, 146, 150, 163, 170, 185, 187, 206, and 207 are also preferred, as they have good polymerization stability and tinting strength.

The amount of colorant is preferably from 1 part by weight to 10 parts by weight based on 100 parts by weight of monovinyl monomer.

It is preferable to add a pigment dispersing agent to stabilize the dispersion state of the colorant in the polymerizable monomer composition. As the pigment dispersing agent, a coupling agent such as an aluminum coupling agent, a silane coupling agent, or a titanium coupling agent is preferable.

### Charge Control Agent

The positive-charging toner according to the present disclosure contains at least a positive-charging charge control agent and may further contain a negative-charging charge control agent within the range of the amount added that makes the toner positively charged.

Examples of positive-charging charge control agents include nigrosine dyes, quaternary ammonium salts, triaminotriphenylmethane compounds, imidazole compounds, and charge control resins such as polyamine resins and copolymers containing quaternary ammonium (salt) groups.

Examples of negative-charging control agents include azo dyes containing a metal such as chromium, cobalt, aluminum, and iron, salicylic acid metal compounds, alkyl salicylic acid metal compounds, and charge control resins such as copolymers containing a sulfonic acid (salt) group and copolymers containing a carboxylic acid (salt) group.

The charge control agent used in the positive-charging toner according to the present disclosure preferably includes a charge control resin, since this improves the printing durability of the toner. Of the charge control agents, a charge control resin may be used in combination with a non-resin charge control agent, or the charge control resin may be used alone. It is more preferable to use the charge control resin alone.

### Other Additives

It is preferable to use a molecular weight adjusting agent as another additive. Examples of the molecular weight adjusting agent include mercaptans such as t-dodecyl mercaptan, n-dodecyl mercaptan, n-octyl mercaptan, and 2,2,4,6,6-pentamethylheptane-4-thiol. The molecular weight adjusting agent can be added before the start of polymerization or during polymerization. The amount of the molecular weight adjusting agent is preferably from 0.01 parts by weight to 10 parts by weight, and more preferably from 0.1 parts by weight to 5 parts by weight based on 100 parts by weight of the monovinyl monomer.

Furthermore, as other additives, it is preferable to add a release agent, which can improve the releasability of the toner from the fixing roller during fixing.

The type of release agent is not particularly limited, and any agent generally used as a toner release agent can be used. For example, low-molecular-weight polyolefin waxes such as low-molecular-weight polyethylene, low-molecular-weight polypropylene, and low-molecular-weight polybutylene; terminally modified polyolefin waxes such as low-molecular-weight polypropylene with molecular end oxidation, low-molecular-weight terminally modified polypropylene with molecular end substituted with an epoxy group, block polymers of these and low-molecular-weight polyethylene, low-molecular-weight polyethylene with molecular end oxidation, low-molecular-weight polyethylene with molecular end substituted with an epoxy group, and block polymers of these and low-molecular-weight polypropylene; natural plant waxes such as candelilla, carnauba, rice, wood wax, and jojoba; petroleum waxes such as paraffin, microcrystalline wax, and petrolatum and modified waxes thereof; mineral waxes such as montan wax, ceresin and ozokerite; synthetic waxes such as Fischer-Tropsch wax; polyhydric alcohol esters compounds such as pentaerythritol esters such as pentaerythritol tetramyristate, pentaerythritol tetrapalmitate, pentaerythritol tetrastearate and pentaerythritol tetralaurate, and dipentaerythritol esters such as dipentaerythritol hexamyristate, dipentaerythritol hexapalmitate and dipentaerythritol hexalaurate; and the like. These may be used alone or in combination of two or more.

The release agent is preferably used in an amount of from 0.1 parts by weight to 30 parts by weight, more preferably from 1 part by weight to 20 parts by weight per 100 parts by weight of the monovinyl monomer.

### External Additive

As the inorganic fine particles used as the external additive, those having a number-average particle diameter of the primary particles of from 4 nm to 80 nm are preferred, and those having a number-average particle diameter of from 6 nm to 40 nm are more preferred. Furthermore, in addition to the above inorganic fine particles, it is more preferred to use inorganic fine particles having a number-average particle diameter of the primary particles of from 100 nm to 200 nm in combination. This ensures the flowability of the toner throughout durability, and makes it easier to improve the concentration. The inorganic fine particles are added to improve the flowability of the toner and to control the charging performance of the toner particle.

In the present disclosure, it is preferred to select inorganic fine particles from the viewpoint of controlling the triboelectric series of the toner, and inorganic fine particles having amino groups at the surface are preferred. By using the inorganic fine particles having amino groups at the surface, the triboelectric series can be controlled to a positive charging performance, and such inorganic fine particles can be obtained by treating the inorganic fine particle surface with a treatment agent such as an aminosilane compound or amino-modified silicone oil.

Examples of aminosilane compounds include γ-aminopropyltriethoxysilane, γ-(2-aminoethyl)aminopropyltrimethoxysilane, γ-(2-aminoethyl)aminopropylmethyldimethoxysilane, aminosilane, N-(2-aminoethyl)3-aminopropyltrimethoxysilane, N-β-(N-vinylbenzylaminoethyl)-γ-aminopropyltrimethoxysilane, and the like.

The number-average particle diameter of the primary particles of the inorganic fine particles is measured using a photograph of the toner taken enlarged with a scanning electron microscope (SEM).

Examples of inorganic fine particles that can be used include fine particles of silica, titanium oxide, aluminum oxide, zinc oxide, and the like, or fine particles of composite oxides thereof. Examples of silica fine particles include dry silica and wet silica, known as the so-called dry-method or fumed silica, which are produced by the vapor phase oxidation of silicon halides.

The amount of inorganic fine particles added is preferably from 0.1 parts by mass to 4.0 parts by mass per 100 parts by mass of toner particles. The content of inorganic fine particles can be quantified using a calibration curve prepared from a standard sample by using X-ray fluorescence analysis.

### Developing Cartridge, Process Cartridge, and Electrophotographic Image Forming Apparatus

The developing roller according to the present disclosure can be suitably used as a developing roller in a developing cartridge or a toner supply roller. One aspect of the present disclosure may be a process cartridge including a developing cartridge having the developing roller according to the present disclosure and an image-bearing member to which toner is supplied from the developing cartridge to form a toner image. Yet another aspect of the present disclosure may be an electrophotographic image forming apparatus including an exposure device that exposes the image-bearing member of the process cartridge to light to form an electrostatic latent image on the image-bearing member, a transfer device that transfers the toner image formed by the process cartridge onto the recording sheet, and a fixing device that fixes the image formed on the recording sheet. In addition, as another aspect of the present disclosure, the developing roller according to the present disclosure can be suitably used as a developing roller in an electrophotographic image forming apparatus or a toner supply roller.

### Overall Configuration of Electrophotographic Image Forming Apparatus

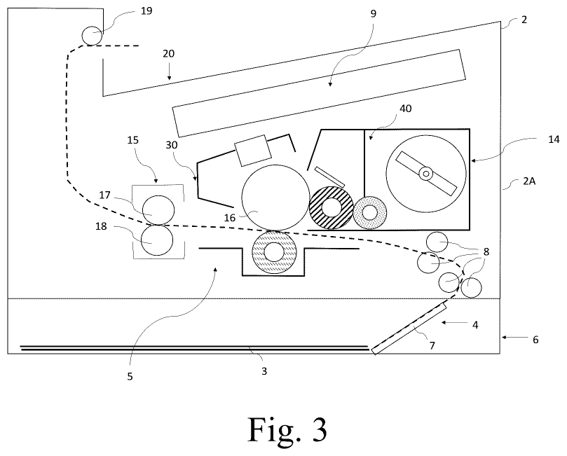

FIG. 3 is a schematic cross-sectional view of an example of an electrophotographic image forming apparatus according to one embodiment of the present disclosure. As shown in FIG. 3, a paper feed unit 4 for feeding paper 3 as an example of a recording medium, an image forming unit 5 for forming an image on the fed paper 3, and the like are provided in a main casing 2.

The paper feed unit 4 mainly includes a paper feed tray 6 detachably attached to the bottom of the main casing 2, and a paper pressure plate 7 provided within the paper feed tray 6. The paper feed unit 4 also includes various rollers 8 for transporting the paper 3 and removing paper dust. In the paper feed unit 4 thus configured, the paper 3 in the paper feed tray 6 is pushed upward by the paper pressure plate 7 and transported to the image forming unit 5 by the various rollers 8.

The image forming unit 5 includes an exposure unit 9 as an example of an exposure device, a process cartridge 14, a fixing unit 15 as an example of a fixing device, and the like.

The exposure unit 9 is located at the top of the main casing 2. The exposure unit 9 radiates a laser beam based on image data toward the photosensitive drum 16, exposing the photosensitive drum 16.

The process cartridge 14 will be explained in detail in the next section.

As shown in FIG. 3, the fixing unit 15 is provided downstream of the process cartridge 14 and mainly consists of a heating roller 17 and a pressure roller 18 that is arranged opposite the heating roller 17 and presses the heating roller 17. In the fixing unit 15 configured in this way, the toner transferred onto the paper 3 is thermally fixed while the paper 3 passes between the heating roller 17 and the pressure roller 18. The paper 3 on which the toner has been thermally fixed in the fixing unit 15 is transported by a paper discharge roller 19 provided downstream of the fixing unit 15 and sent onto the paper discharge tray 20.

### Process Cartridge

The process cartridge 14 is structured so as to be detachably attached to the main casing 2 by opening, as appropriate, the front cover 2A provided on the front side of the main casing 2. This process cartridge 14 is mainly configured of a drum cartridge 30 and a developing cartridge 40 that is detachably attached to the drum cartridge 30. The drum cartridge 30 may be either fixed in the main casing 2 or removable from the main casing 2.

### Developing Cartridge

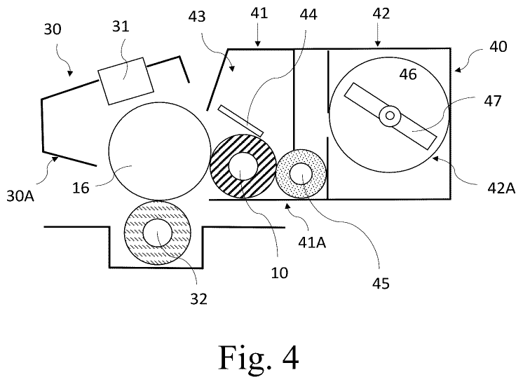

The developing cartridge 40 is configured of a developing unit 41 and a toner unit 42. FIG. 4 is a schematic cross-sectional view of an example of a process cartridge according to one aspect of the present disclosure.

As shown in FIG. 4, the developing unit 41 mainly includes a developing case 41A forming a toner chamber 43, a developing roller 10, a toner layer thickness control member 44, and a supply roller 45 that slides against the developing roller 10. A predetermined bias is applied to the toner layer thickness control member 44 to impart an electric charge to the toner.

As shown in FIG. 4, the toner unit 42 mainly includes a toner case 42A forming a toner storage chamber 46 and an agitator 47 that transports the toner stored in the toner storage chamber 46 to the toner chamber 43. The toner unit 42 may be configured to be detachable from the developing cartridge 40 or may be fixed to the developing cartridge 40.

The toner contained in the toner storage chamber 46 is supplied from the toner storage chamber 46 into the toner chamber 43 and is supplied to the developing roller 10 by the supply roller 45 or directly. The toner supplied onto the developing roller 10 enters between the toner layer thickness control member 44 and the developing roller 10 as the developing roller 10 rotates and is carried on the developing roller 10 as a thin layer of a constant thickness.

### Drum Cartridge

The drum cartridge 30 mainly includes a photosensitive drum 16, a scorotron charger 31, and a transfer roller 32.

The photosensitive drum 16 is rotatably supported by a drum case 30A, and is arranged to contact the developing roller 10 when the developing cartridge 40 is attached to the drum cartridge 30.

The scorotron charger 31 is a positive-charging scorotron-type charger that generates a corona discharge from a charging wire made of tungsten or the like and is configured to uniformly charge the surface of the photosensitive drum 16 to a positive polarity.

The transfer roller 32 is disposed below the photosensitive drum 16 so as to face and contact the photosensitive drum 16 and is rotatably supported by the drum case 30A. A transfer bias is applied to the transfer roller 32 by constant current control during transfer.

In the process cartridge 14 configured in this manner, the surface of the photosensitive drum 16 is uniformly positively charged by the scorotron charger 31 and then exposed by high-speed scanning of a laser beam from the exposure unit 9. This reduces the potential of the exposed portion, and an electrostatic latent image based on the image data is formed.

Here, the electrostatic latent image refers to the exposed portion of the surface of the photosensitive drum 16 that has been uniformly positively charged. This portion is exposed by the laser beam and has a reduced potential.

Next, as the developing roller 10 rotates, the toner carried on the developing roller 10 is supplied to the electrostatic latent image formed on the surface of the photosensitive drum 16 when the developing roller facing the photosensitive drum 16 comes into contact therewith. In this way, the toner is selectively carried on the surface of the photosensitive drum 16, thereby enabling visualization and formation of a toner image by reverse development.

Then, the photosensitive drum 16 and the transfer roller 32 are rotationally driven so as to sandwich and transport the paper 3 therebetween, and the toner image carried on the surface of the photosensitive drum 16 is transferred onto the paper 3 as the paper 3 is transported between the photosensitive drum 16 and the transfer roller 32.

### <Measurement of Amount of Amino Groups at Surface>

The abundance ratio of amino groups at the outermost surface of the developing roller is measured using a time-of-flight secondary ion mass spectrometer (TOF-SIMS). More specifically, this measurement is performed under the following conditions using a time-of-flight secondary ion mass spectrometer (product name: TRIFT II, manufactured by ULVAC-PHI, Inc.).
Primary ion species: Ga+
Primary ion current (DC): 600 pA
Primary ion energy: 15 kV
Sample potential: +3.2 kV
Secondary ion detection mode: Positive
Measurement vacuum: 1×10⁻⁷ Pa
Measurement area: 100 μm×100 μm
Measurement integration time: 300 sec

The percentage of ion intensity derived from amino groups relative to all detected ions is calculated from the peak intensity of the obtained ions, and this is taken as the abundance ratio of amino groups at the outermost surface of the developing roller.

As for the discrimination of amino group-derived fragments, the selection is performed, as appropriate, based on the structure of the acrylic resin estimated by nuclear magnetic resonance (NMR) etc. Examples of peaks derived from amino groups include [C₂H₄N], [C₂H₅N], [C₃H₆N], [C₃H₈N], [C₄H₁₀N], [C₅H₁₂N], [C₆H₁₄N], etc.

### Measurement of Amount of Si, F, and Cl Surface Elements

The abundance ratio of silicon, fluorine, and chlorine at the outermost surface of the developing roller (hereinafter abbreviated as Si/F/Cl amount) is measured using X-ray photoelectron spectroscopy (XPS). More specifically, this measurement is performed using an X-ray photoelectron spectroscopy device (product name: Quantum 2000 Scanning ESCA Microprobe, manufactured by PHI (Physical Electronics Industries, Inc.) under the following conditions.
Excitation X-ray: Al Kα
Photoelectron escape angle: 45°
X-ray: 100 μm, 25 W, 15 kV
Electron neutralization gun: 20 μA, 1 V
Ion neutralization gun: 7 mA, 10V
Analysis area: 300 μm×200 μm
Pass energy: 58.70 eV
Step size: 0.125 eV
Sweep: F (10 times), C (10 times), O (10 times), Si (30 times), N (30 times), Cl (10 times).

From the peak intensity of each element obtained, the surface atomic concentration (Atomic %) is calculated using the relative sensitivity factor provided by PHI, Inc., and these are taken as the abundance ratios of Si/F/Cl to the constituent elements at the outermost surface of the resin layer.

### Volume Resistivity

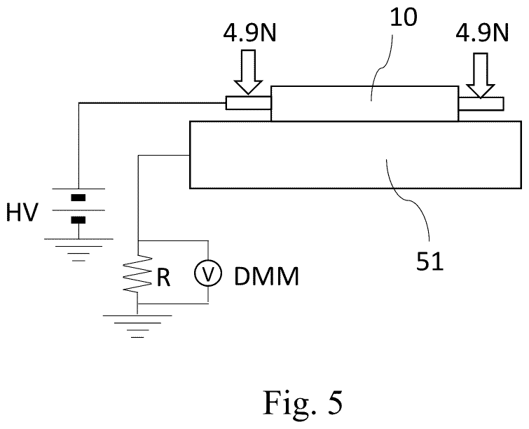

The volume resistivity is measured using an electrical resistance measuring device as shown in FIG. 5.

A load of 4.9 N is applied to both ends of the shaft of the developing roller 10, and the developing roller 10 is placed in contact with a metal drum 51 having a diameter of 50 mm. The metal drum 51 is rotated at a surface speed of 50 mm/sec, and the developing roller 10 is rotationally driven thereby. A resistor R having a known electrical resistance that is at least two orders of magnitude lower than the electrical resistance of the developing roller 10 is connected between the metal drum 51 and ground (GND). A voltage of +50 V is applied to the shaft of the developing roller 10 from a high-voltage power source HV, and the potential difference between both ends of the resistor R is measured using a digital multimeter (for example, 189 TRUE RMS MULTIMETER manufactured by Fluke Corporation). The current flowing through the metal drum 51 via the developing roller 10 is determined from the measured value of potential difference and the electrical resistance of the resistor R, and the electrical resistance value of the developing roller 10 is determined by calculation from this current and the applied voltage of 50 V. Measurements using the digital multimeter are performed by 3-sec sampling starting 2 sec after the voltage is applied, and the value calculated from the average value is the resistance value of the developing roller. Next, the area of the contact portion between the developing roller 10 and the metal drum 51 is calculated. The volume resistivity of the developing roller is calculated from the resistance value of the developing roller, the area of the contact portion, and the thickness of the rubber of the developing roller. Specifically, the volume resistivity is calculated using the following formula (1).

$$Volume resistivity {ρ}_{v} = R \times \frac{S}{L} . \qquad ( 1 )$$

Here, R: resistance value, S: area of the contact portion, L: thickness of the rubber of the developing roller.

### Method for Measuring Elastic Modulus

The elastic modulus of the developing roller in the present disclosure is measured using a scanning probe microscope (SPM).

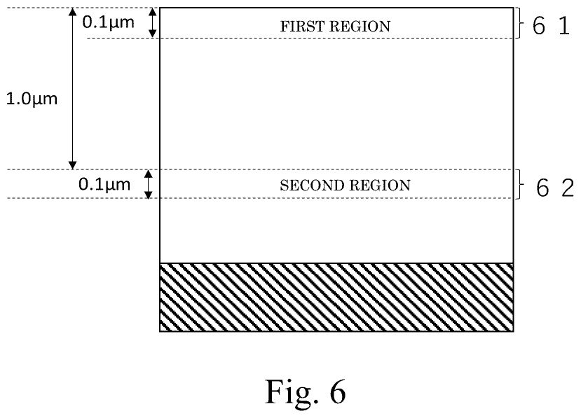

First, a region of the cross-sectional area of the developing roller to be measured is cut into a thin section using a diamond knife with a cryomicrotome (product name: EMFC6, manufactured by Leica Microsystems, Inc.) while keeping the temperature at −110° C. Then, a sample with a size of 100 μm square and a width of 100 μm in the depth direction is prepared from the thin section. FIG. 6 shows a schematic cross-sectional view of a resin layer 12 formed on a conductive substrate 11. In the present disclosure, as shown in FIG. 6, a first region 61 is defined as a region from the outermost surface of the resin layer 12 forming the outermost surface of the developing roller to a depth of 0.1 μm, and the second region 62 is defined as a region at a depth of from 1.0 μm to 1.1 μm from the outermost surface. The elastic modulus is measured in each region appearing on the cross section of the prepared sample. For the measurement, a scanning probe microscope (product name: MFP-3D-Origin, manufactured by Oxford Instruments) and a probe (product name: AC160, manufactured by Olympus Corporation) are used. At this time, the force curve is measured 10 times, the arithmetic average of the 8 points excluding the maximum and minimum values is calculated, and the elastic modulus is calculated by Hertz theory. The elastic modulus in the first region 61 and the second region 62 is defined as E1 and E2, respectively.

### Verification of IPN Structure

The IPN structure of the resin layer is verified by microsampling mass spectrometry. Microsampling mass spectrometry uses an ion trap mass spectrometer. A sample is fixed to a filament located at the tip of a probe and directly inserted into the ionization chamber. It is then rapidly heated from room temperature to a temperature of 1000° C. at a constant heating rate. The sample decomposed and evaporated by heating is ionized by irradiation with an electron beam and detected by a mass spectrometer. At this time, under conditions of a constant heating rate, a thermal chromatogram similar to the TG-MS (thermogravimetry-mass spectrometry analysis) method is obtained, which has a mass spectrum called a total ion chromatogram (TIC). In addition, since a thermal chromatogram for a fragment of a predetermined mass can be obtained, it is possible to obtain a peak temperature of the thermal chromatogram that corresponds to the decomposition temperature of a desired molecular structure.

The peak temperature of the thermal chromatogram is correlated with the crosslinked structure in the resin structure, and as the crosslinking becomes denser, the peak temperature shifts to a high-temperature side. In other words, compared to the crosslinked acrylic resin alone, the peak temperature of the thermal chromatogram is higher in a portion where the crosslinked urethane resin and the crosslinked acrylic resin form an IPN structure.

A peak top temperature A1 of the thermal chromatogram originating from the crosslinked acrylic resin is obtained from a first sample in the first region. Furthermore, a peak top temperature A2 of the thermal chromatogram originating from the crosslinked acrylic resin measured from a second sample obtained by decomposing the crosslinked urethane resin contained in the first sample is obtained. The peak top temperatures A1 and A2 of the thermal chromatogram are compared, and when A1 is higher than A2, it means that the crosslinked urethane resin and the crosslinked acrylic resin have formed an IPN structure. A2 is a value obtained by performing microsampling mass spectrometry on a second sample obtained after decomposing the crosslinked urethane by the pyridine decomposition method described hereinbelow.
A2 can be, for example, from 390° C. to 396° C. or from 391° C. to 395° C.
A1 can be, for example, from 393° C. to 398° C. or from 394° C. to 397° C.

### Pyridine Decomposition Method

The pyridine decomposition method is a method for selectively decomposing urethane bonds. By performing the pyridine decomposition method on a sample having an IPN structure of crosslinked acrylic resin and crosslinked urethane resin, it is possible to obtain crosslinked acrylic resin after removing the structure derived from the crosslinked urethane. The presence or absence of an IPN structure can be confirmed by capturing the change in peak temperature of the thermal chromatogram of this crosslinked acrylic resin. Specifically, the pyridine decomposition method is performed as follows.

Using a microtome, a sample is cut out from the surface of the developing roller at a thickness of 0.1 μm, and 500 mg of the sample is collected. To the obtained sample, 0.5 mL of a mixture of pyridine (manufactured by Fujifilm Wako Pure Chemical Industries, Ltd.) and water in a ratio of 3:1 is added, and the mixture is decomposed by heating at 130° C. for 15 h in a sealed container made of fluororesin (Teflon (registered trademark)) with a stainless steel jacket. The pyridine is removed by depressurizing the decomposition product obtained. The above-mentioned microsampling mass spectrometry is performed using the sample thus obtained to obtain the value of A2.

### Structural Analysis of Crosslinked Acrylic Resin

The content of amino groups in the crosslinked acrylic resin molecule can be analyzed by known means such as a pyrolysis gas chromatograph mass spectrometer (GC/MS), a Fourier transform infrared spectrometer (FT-IR), or a nuclear magnetic resonance device (NMR).

In the present disclosure, the structure derived from the crosslinked urethane is removed by the pyridine method, and the obtained crosslinked acrylic resin is confirmed using an FT-IR (product name: FT/IR-4700, manufactured by JASCO Corporation).

### EXAMPLES

The present disclosure will be described in more detail below with reference to examples, but these are not intended to limit the present disclosure in any way.

### Example 1

### 1. Production of Developing Roller

In this example, a developing roller in which a resin layer is coated on an elastic roller having an elastic layer on the outer surface of a substrate is described, but the present disclosure is not limited to this configuration.

### 1-1. Preparation of Substrate

The substrate was prepared by coating a primer (product name: DY35-051, manufactured by Dow Toray Co., Ltd.) on the peripheral surface of a stainless steel (SUS304) core bar having a diameter of 8 mm and baking.

### 1-2. Preparation of Elastic Layer

The substrate was placed in a mold, and an addition type silicone rubber composition prepared by mixing the materials shown in Table 1 was injected into the cavity formed in the mold.

TABLE 1

| | Parts |
|---|---|
| Material | by mass |
| Liquid silicone rubber (product name: SE6724 A/B, | 100 |
| manufactured by Dow Toray Co., Ltd.) | |
| Carbon black (product name TOKABLACK #4300, | 16 |
| manufactured by Tokai Carbon Co., Ltd.) | |
| Curing control agent (product name: 1-ethynyl-1-cyclohexanol, | 0.01 |
| manufactured by Tokyo Kasei Kogyo Co., Ltd.) | |
| Platinum catalyst (trade name: SIP6830.3, manufactured by | 0.01 |
| GELEST, Inc.) | |

Then, the mold was heated to vulcanize and cure the addition type silicone rubber composition at a temperature of 150° C. for 15 min, and after demolding, the composition was further heated at a temperature of 180° C. for 1 h to complete the curing reaction, and an elastic roller with an elastic layer of 20 mm in diameter on the outer periphery of the substrate was obtained.

### 1-3. Formation of Resin Layer

The materials in Table 2 below, other than the roughness-forming particles, were mixed and stirred as materials for the resin layer. Then, they were dissolved in 2-butanone (MEK, manufactured by Kishida Chemical Co., Ltd.) to a solid fraction concentration of 30% by mass, mixed, and uniformly dispersed with a sand mill. 2-butanone (MEK) was added to this liquid mixture to adjust the solid fraction concentration to 25.0% by mass, the material shown in the column for roughness-forming particles in Table 2 was added, and the mixture was stirred and dispersed with a ball mill to prepare a resin layer forming coating material 1.

TABLE 2

| | Parts |
|---|---|
| Material | by mass |
| Polyether polyol (product name: PTGL1000, | 100 |
| manufactured by Hodogaya Chemical Co., Ltd.) | |
| Polymeric MDI (product name: MR-400, manufactured | 36.0 |
| by Tosoh Corporation) | |
| Carbon black (product name: SUNBLACK X15, | 29.3 |
| manufactured by Asahi Carbon Co., Ltd.) | |
| Roughness-forming particles (product name: | 17.6 |
| Dynamic Beads UCN-5090, manufactured by | |
| Dainichiseika Color & Chemicals Mfg. Co., Ltd.) | |

Then, the elastic roller was immersed (dipped) into the resin layer forming coating material 1, the upper end of the elastic roller being held so that the lengthwise direction thereof was the vertical direction. The coating liquid was applied to the surface of the elastic roller. The resulting coating was air-dried at room temperature for 30 min, and then dried for 1 h in a hot air circulating dryer set at 160° C. In this way, a resin layer with a thickness of about 15 μm was formed on the elastic layer.

### 1-4. Impregnation Treatment

The impregnation and curing treatment of the acrylic monomer was carried out by the following method. The materials shown in Table 3 below were dissolved and mixed as the materials for the impregnation treatment liquid for the impregnation treatment to prepare an impregnation treatment liquid 1. The elastic roller with the resin layer formed thereon was dipped in the impregnation treatment liquid 1 for 2 sec to perform the treatment, and the acrylic monomer component was impregnated. After that, drying was immediately performed at 90° C. for 1 h to volatilize the solvent. After drying, the elastic roller was rotated while being irradiated with ultraviolet light so that the cumulative light quantity was 15,000 mJ/cm², thereby curing the acrylic monomer, forming an IPN structure, and producing a developing roller 1. A high-pressure mercury lamp (product name: Handy Type UV curing device, manufactured by Mario Network Co., Ltd.) was used as the ultraviolet light irradiation device.

TABLE 3

| | Parts |
|---|---|
| Material | by mass |
| Aminoacrylic monomer (product name: EBECRYL 7100, | 5.0 |
| manufactured by Daicel-Allnex Co., Ltd.) | |
| Photopolymerization initiator (product name: Omnirad | 0.25 |
| 184, manufactured by IGM Resins B.V.) | |
| Solvent (product name: 2-butanone, manufactured | 100 |
| by Kishida Chemical Co., Ltd.) | |

### 2. Physical Property Evaluation and Analysis

For the developing roller 1, the following were carried out: volume resistivity measurement, elastic modulus measurement using a scanning probe microscope (SPM), measurement of amino groups at the outermost surface using a time-of-flight secondary ion mass spectrometer (TOF-SIMS), Si/F/Cl amount measurement using X-ray photoelectron spectroscopy (XPS), and peak temperature measurement of thermal chromatogram using microsampling mass spectrometry. Details of each measurement method are as described above.

The obtained physical properties and analysis results of the developing roller 1 are shown in Table 7.

### 3. Image Evaluation

The image evaluation method is explained hereinbelow.

As an electrophotographic image forming apparatus, a modified HL-5440D (manufactured by Brother Industries, Ltd.), which is a commercially available monochrome laser printer, was used. The modification involved connecting the printer to an external high-voltage power source so that a freely selected potential difference could be set between the toner layer thickness control member and the developing roller, and in order to perform evaluation in a high-speed process, the output number per unit time was set to 50 sheets/minute for A4 size paper. The process cartridge used was a modified version of a commercially available toner cartridge TN-56J (manufactured by Brother Industries, Ltd.), and the developing roller was replaced with the developing roller 1. The modification of the cartridge consisted in providing a rotating gear that matched the shape of the developing roller.

### Fogging Evaluation

The prepared process cartridge was mounted in the main body of an electrophotographic image forming apparatus and allowed to stand in an environment of 30° C. temperature and 80% relative humidity for 24 h. After that, an external high-voltage power source was used to set the potential difference between the toner layer thickness control member and the developing roller to +300V. In the same environment, an image of the alphabet letter “E” with a size of 4 points and a print percentage of 2% with respect to the area of an A4 size paper was continuously output on the A4 evaluation paper (GF-C081, manufactured by Canon Inc.). A solid white image was output every 1000 sheets, the toner was replenished every 8000 sheets, and this was repeated up to 20,000 sheets. The fogging value was measured using the following method.

Using a reflection densitometer (product name: TC-6DS/A, manufactured by Tokyo Denshoku Technology Center Co., Ltd.), the reflection density R1 of the recording material before image formation and the reflection density R2 of the recording material on which a solid white image was output were measured, and the increase in reflection density (R2−R1) was taken as the “fogging value” of the developing roller. The reflection density was measured over the entire image printing area of the recording material, the arithmetic mean value was used for the recording material before image formation, and the maximum value was used for the recording material on which a solid white image was output. Next, the arithmetic mean value of the fogging values of each image up to 20,000 sheets was calculated. The smaller the fogging value, the better, and usually toner is not transferred onto the transfer paper on which a solid white image has been formed. When the toner is not charged enough, the toner moves onto the photosensitive member even when a solid white image is formed, and is then transferred onto the transfer paper, increasing the fogging value. The evaluation results are shown in Table 7.

Since fogging tends to worsen in high-temperature and high-humidity environments with a temperature of 30° C. and a relative humidity of 80%, the evaluation was performed in the above environment.

### Image Density Stability Evaluation

The prepared process cartridge was mounted in the main body of the electrophotographic image forming apparatus and allowed to stand for 24 h in an environment with a temperature of 15° C. and a relative humidity of 10%. After that, an external high-voltage power source was used to set the potential difference between the toner layer thickness control member and the developing roller to +300 V, and one halftone image of 25% with respect to solid black, 48 solid white images, and one halftone image of 25% with respect to solid black were output in this order. The densities of the obtained first and 50th halftone images were measured using a spectrodensitometer (product name: 508, manufactured by X-Rite, Inc.), and the density difference between the first and 50th sheets was obtained. The smaller the density difference, the better. The evaluation results are shown in Table 7.

### Examples 2 to 13 and Comparative Examples 1 to 7

In Examples 2 to 13 and Comparative Examples 1 to 7, resin layer forming coating materials 2 to 9 were prepared using the materials and numbers of parts shown in Table 4 in the same manner as in Example 1, impregnation treatment liquids 2 to 11 were prepared using the materials and parts shown in Table 5, and developing rollers 2 to 20 were produced using the combinations shown in Table 6. The resulting developing rollers were subjected to physical property evaluation, analysis, and image evaluation in the same manner as in Example 1. The evaluation results are shown in Table 7.

TABLE 4

| | | | | | | | Roughness forming | | | |
|---|---|---|---|---|---|---|---|---|---|---|
| | Polyol | | Isocyanate | | Carbon black | | particles | | Additive | |
| | Material | Parts | Material | Parts | Material | Parts | Material | Parts | Material | Parts |
| No. | name | by mass | name | by mass | name | by mass | name | by mass | name | by mass |
| Resin layer forming | PTGL1000 | 100 | MR-400 | 36.0 | SUNBLACK X15 | 29.3 | UCN-5090 | 17.6 | — | — |
| coating material 1 | | | | | | | | | | |
| Resin layer forming | PTGL1000 | 100 | MR-400 | 36.0 | SUNBLACK X15 | 29.3 | UCN-5090 | 17.6 | TSF4445 | 1.2 |
| coating material 2 | | | | | | | | | | |
| Resin layer forming | PTGL1000 | 100 | MR-400 | 36.0 | SUNBLACK X15 | 29.3 | UCN-5090 | 17.6 | Surflon S-656 | 0.8 |
| coating material 3 | | | | | | | | | | |
| Resin layer forming | PTGL1000 | 100 | MR-400 | 36.0 | SUNBLACK X15 | 29.3 | UCN-5090 | 17.6 | TSF4445 | 0.6 |
| coating material 4 | | | | | | | | | Surflon S-656 | 0.4 |
| Resin layer forming | PTGL1000 | 100 | MR-400 | 36.0 | SUNBLACK X15 | 46.9 | UCN-5090 | 17.6 | — | — |
| coating material 5 | | | | | | | | | | |
| Resin layer forming | PTGL3500 | 100 | MR-400 | 6.3 | SUNBLACK X15 | 26.3 | UCN-5090 | 15.8 | — | — |
| coating material 6 | | | | | | | | | | |
| Resin layer forming | PTGL1000 | 100 | MR-400 | 36.0 | SUNBLACK X15 | 29.3 | UCN-5090 | 17.6 | TSF4445 | 1.5 |
| coating material 7 | | | | | | | | | | |
| Resin layer forming | PTGL1000 | 100 | MR-400 | 36.0 | SUNBLACK X15 | 61.5 | UCN-5090 | 17.6 | — | — |
| coating material 8 | | | | | | | | | | |
| Resin layer forming | PTGL1000 | 100 | MR-400 | 36.0 | SUNBLACK X15 | 29.3 | UCN-5090 | 17.6 | Polyment NK- | 5.0 |
| coating material 9 | | | | | | | | | 380 | |

*The materials listed in the table are as follows.
“PTGL1000”: product name, manufactured by Hodogaya Chemical Co., Ltd.
“PTGL3500”: product name, manufactured by Hodogaya Chemical Co., Ltd.
“MR-400 (Millionate MR-400)”: product name, manufactured by Tosoh Corporation
“SUNBLACK X15”: product name, manufactured by Asahi Carbon Co., Ltd.
“UCN-5090 (Dynamic Beads UCN-5090)”: product name, manufactured by Dainichiseika Color & Chemicals Mfg. Co., Ltd.
“TSF4445”: product name, manufactured by Momentive Performance Materials Japan LLC, polyether-modified silicone oil
“Surflon S-656”: product name, manufactured by AGC Seimi Chemical Co., Ltd., fluorosurfactant
“Polyment NK-380”: product name, manufactured by Nippon Shokubai Co., Ltd., aminoethylated acrylic polymer

TABLE 5

| | | | | | Photopolymerization | | | |
|---|---|---|---|---|---|---|---|---|
| | Aminoacrylate | | Acrylic monomer | | initiator | | Solvent | |
| | | Parts | | Parts | | Parts | | Parts |
| No. | Material name | by mass | Material name | by mass | Material name | by mass | Material name | by mass |
| Impregnation treatment liquid 1 | EBECRYL 7100 | 5 | — | — | Omnirad184 | 0.25 | MEK | 100 |
| Impregnation treatment liquid 2 | CN371 | 5 | — | — | Omnirad184 | 0.25 | MEK | 100 |
| Impregnation treatment liquid 3 | EBECRYL 80 | 5 | — | — | Omnirad184 | 0.25 | MEK | 100 |
| Impregnation treatment liquid 4 | Aron DA | 5 | — | — | Omnirad184 | 0.25 | MEK | 100 |
| Impregnation treatment liquid 5 | EBECRYL 7100 | 1.5 | EBECRYL 145 | 3.5 | Omnirad184 | 0.25 | MEK | 100 |
| Impregnation treatment liquid 6 | EBECRYL 7100 | 10 | — | — | Omnirad184 | 0.25 | MEK | 100 |
| Impregnation treatment liquid 7 | EBECRYL 7100 | 1.5 | EBECRYL 145 | 1 | Omnirad184 | 0.25 | MEK | 100 |
| Impregnation treatment liquid 8 | EBECRYL 7100 | 1.5 | TMPTA | 1 | Omnirad184 | 0.25 | MEK | 100 |
| Impregnation treatment liquid 9 | EBECRYL 7100 | 1 | — | — | Omnirad184 | 0.25 | MEK | 100 |
| Impregnation treatment liquid 10 | EBECRYL 7100 | 1.5 | EBECRYL 145 | 0.75 | Omnirad184 | 0.25 | MEK | 100 |
| Impregnation treatment liquid 11 | — | — | EBECRYL 145 | 5 | Omnirad184 | 0.25 | MEK | 100 |

*The materials listed in the table are as follows.
“EBECRYL7100”: product name, manufactured by Daicel-Allnex Co., Ltd.
“CN371”: product name, manufactured by Tomoe Engineering Co., Ltd.
“EBECRYL80”: product name, manufactured by Daicel-Allnex Co., Ltd.
“Aron DA”: product name, manufactured by Toagosei Co., Ltd.
“EBECRYL145”: product name, manufactured by Daicel-Allnex Co., Ltd.
“TMPTA”: product name, manufactured by Daicel-Allnex Co., Ltd.
“Omnirad 184”: product name, manufactured by IGM Resins B.V.
“MEK (2-butanone)”: product name, manufactured by Kishida Chemical Co., Ltd.

TABLE 6

| | Developing | Resin layer forming | Impregnation |
|---|---|---|---|
| | roller No. | coating material No. | liquid No. |
| Example 1 | Developing | Resin layer forming | Impregnation |
| | roller 1 | coating material 1 | liquid 1 |
| Example 2 | Developing | Resin layer forming | Impregnation |
| | roller 2 | coating material 1 | liquid 2 |
| Example 3 | Developing | Resin layer forming | Impregnation |
| | roller 3 | coating material 1 | liquid 3 |
| Example 4 | Developing | Resin layer forming | Impregnation |
| | roller 4 | coating material 1 | liquid 4 |
| Example 5 | Developing | Resin layer forming | Impregnation |
| | roller 5 | coating material 1 | liquid 5 |
| Example 6 | Developing | Resin layer forming | Impregnation |
| | roller 6 | coating material 1 | liquid 6 |
| Example 7 | Developing | Resin layer forming | Impregnation |
| | roller 7 | coating material 2 | liquid 1 |
| Example 8 | Developing | Resin layer forming | Impregnation |
| | roller 8 | coating material 3 | liquid 1 |
| Example 9 | Developing | Resin layer forming | Impregnation |
| | roller 9 | coating material 4 | liquid 1 |
| Example 10 | Developing | Resin layer forming | Impregnation |
| | roller 10 | coating material 1 | liquid 7 |
| Example 11 | Developing | Resin layer forming | Impregnation |
| | roller 11 | coating material 5 | liquid 1 |
| Example 12 | Developing | Resin layer forming | Impregnation |
| | roller 12 | coating material 6 | liquid 1 |
| Example 13 | Developing | Resin layer forming | Impregnation |
| | roller 13 | coating material 1 | liquid 8 |
| Comparative | Developing | Resin layer forming | Impregnation |
| Example 1 | roller 14 | coating material 1 | liquid 9 |
| Comparative | Developing | Resin layer forming | Impregnation |
| Example 2 | roller 15 | coating material 7 | liquid 1 |
| Comparative | Developing | Resin layer forming | Impregnation |
| Example 3 | roller 16 | coating material 1 | liquid 10 |
| Comparative | Developing | Resin layer forming | Impregnation |
| Example 4 | roller 17 | coating material 8 | liquid 1 |
| Comparative | Developing | Resin layer forming | Impregnation |
| Example 5 | roller 18 | coating material 1 | liquid 11 |
| Comparative | Developing | Resin layer forming | — |
| Example 6 | roller 19 | coating material 9 | |
| Comparative | Developing | Resin layer forming | — |
| Example 7 | roller 20 | coating material 1 | |

TABLE 7

| | | | XPS | | | | | | | | |
|---|---|---|---|---|---|---|---|---|---|---|---|
| | | TOF-SIMIS | Si/F/Cl | | | Volume | | | IPN | | |
| | | amino group | amount | E1 | E2 | resistivity | | | present/ | | Density |
| | Developing roller No. | amount [%] | [atm %] | [MPa] | [MPa] | [Ω · cm] | A1 | A2 | absent | Fogging | stability |
| Example 1 | Developing roller 1 | 3.8 | 0.8 | 350 | 40 | 2.3 × 10⁸ | 395 | 392 | Present | 0.7 | 0.02 |
| Example 2 | Developing roller 2 | 3.5 | 0.6 | 350 | 40 | 2.1 × 10⁸ | 395 | 392 | Present | 1.1 | 0.03 |
| Example 3 | Developing roller 3 | 3.6 | 0.5 | 360 | 40 | 1.9 × 10⁸ | 395 | 392 | Present | 1.2 | 0.04 |
| Example 4 | Developing roller 4 | 2.5 | 0.5 | 360 | 40 | 1.7 × 10⁸ | 394 | 392 | Present | 1.3 | 0.03 |
| Example 5 | Developing roller 5 | 1.0 | 0.5 | 360 | 40 | 1.3 × 10⁸ | 395 | 392 | Present | 2.3 | 0.07 |
| Example 6 | Developing roller 6 | 9.8 | 0.3 | 420 | 40 | 1.6 × 10⁸ | 395 | 392 | Present | 1.3 | 0.05 |
| Example 7 | Developing roller 7 | 3.1 | 4.9 | 350 | 30 | 2.2 × 10⁸ | 395 | 392 | Present | 2.5 | 0.08 |
| Example 8 | Developing roller 8 | 3.0 | 4.7 | 360 | 40 | 1.5 × 10⁸ | 394 | 392 | Present | 2.8 | 0.08 |
| Example 9 | Developing roller 9 | 3.2 | 4.8 | 360 | 40 | 1.7 × 10⁸ | 395 | 392 | Present | 2.7 | 0.07 |
| Example 10 | Developing roller 10 | 1.0 | 0.6 | 200 | 40 | 2.0 × 10⁸ | 395 | 392 | Present | 2.9 | 0.08 |
| Example 11 | Developing roller 11 | 3.4 | 0.6 | 350 | 40 | 1.2 × 10⁶ | 394 | 392 | Present | 2.9 | 0.07 |
| Example 12 | Developing roller 12 | 3.6 | 0.5 | 330 | 10 | 8.7 × 10⁷ | 394 | 391 | Present | 2.2 | 0.06 |
| Example 13 | Developing roller 13 | 1.2 | 0.5 | 980 | 100 | 9.7 × 10⁷ | 395 | 392 | Present | 2.7 | 0.08 |
| Comparative | Developing roller 14 | 0.7 | 0.6 | 350 | 40 | 1.5 × 10⁸ | 393 | 391 | Present | 3.5 | 0.15 |
| Example1 | | | | | | | | | | | |
| Comparative | Developing roller 15 | 3.2 | 5.0 | 350 | 30 | 2.6 × 10⁸ | 395 | 392 | Present | 3.8 | 0.18 |
| Example2 | | | | | | | | | | | |
| Comparative | Developing roller 16 | 0.9 | 0.6 | 170 | 40 | 9.4 × 10⁷ | 393 | 391 | Present | 5.3 | 0.22 |
| Example3 | | | | | | | | | | | |
| Comparative | Developing roller 17 | 3.1 | 0.9 | 380 | 60 | 4.2 × 10⁵ | 395 | 392 | Present | 4.9 | 0.21 |
| Example4 | | | | | | | | | | | |
| Comparative | Developing roller 18 | 0.0 | 0.7 | 360 | 40 | 1.1 × 10⁸ | 395 | 392 | Present | 4.2 | 0.16 |
| Example5 | | | | | | | | | | | |
| Comparative | Developing roller 19 | 0.8 | 0.7 | 360 | 180 | 3.2 × 10⁸ | 393 | 393 | Absent | 5.1 | 0.20 |
| Example6 | | | | | | | | | | | |
| Comparative | Developing roller 20 | 0.1 | 0.6 | 30 | 30 | 8.6 × 10⁷ | 392 | 392 | Absent | 4.4 | 0.18 |
| Example7 | | | | | | | | | | | |

Examples 1 to 4 use different aminoacrylic monomer/oligomer species for impregnation but show good results in the fogging evaluation and image density stability evaluation. Example 5 shows good results in the fogging evaluation and image density stability evaluation, but since the amount of aminoacrylic monomer/oligomer is reduced, the results are slightly worse than in Examples 1 to 4. Example 6 has a larger amount of aminoacrylic monomer/oligomer, but the change in elastic modulus E2 is small, so the results are similar to those of Examples 1 to 4. Examples 7 to 9 use silicone oil and fluorine-based surfactants, so the toner is assumed to be slightly triboelectrically charged, but good results are obtained. Examples 10 to 13 show good results in the fogging evaluation and the image density stability evaluation, but since they are at the lower limit of the hardness (elastic modulus E1), the lower limit of the volume resistivity, the lower limit of the elastic modulus E2, and the upper limit of the elastic modulus E2 of the impregnating agent, respectively, the results are slightly inferior to those in Examples 1 to 4.

Meanwhile, Comparative Examples 1 to 7 show poor results in the fogging evaluation and the image density stability evaluation at a high process speed and in a configuration with a high blade bias.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-010923, filed Jan. 29, 2024, which is hereby incorporated by reference herein in its entirety.

What is claimed is:

1. A developing roller having a conductive substrate and a resin layer present on the outer surface side of the substrate, wherein
the developing roller is for a positive-charging toner,
the resin layer comprises a crosslinked urethane resin,
an amino group is present at an outermost surface of the resin layer,
where the outermost surface of the resin layer is measured with a time-of-flight secondary ion mass spectrometer (TOF-SIMS), an ion intensity derived from the amino groups relative to all detected ions is 1.0% or more,
where the outermost surface of the resin layer is measured by an X-ray photoelectron spectroscopy (XPS), a ratio of the total of detected values of Si, F, and Cl based on the total of detected values of F, C, O, Si, N, and Cl is less than 5.0 Atomic %,
where an elastic modulus in a first region from the outermost surface of the resin layer to a depth of 0.1 μm is defined as E1, E1 is 200 MPa or more, and
a volume resistivity determined when a metal film is provided directly on the outermost surface of the developing roller and a DC voltage of 50 V is applied in an environment of a temperature of 23° C. and a relative humidity of 50% is 1.0×10⁶ Ω·cm or more.

2. The developing roller according to claim 1, wherein
the resin layer comprises a crosslinked acrylic resin, and
the crosslinked acrylic resin and the crosslinked urethane resin form an interpenetrating polymer network structure.

3. The developing roller according to claim 2, wherein the crosslinked acrylic resin has an amino group.

4. The developing roller according to claim 1, wherein an elastic modulus E2 in a second region at a depth of 1.0 to 1.1 μm from the outermost surface of the resin layer is 1 to 100 MPa.

5. The developing roller according to claim 1, wherein the outermost surface of the resin layer is the outermost surface of the developing roller.

6. A developing cartridge configured to be detachably attached to a main body of an electrophotographic image forming apparatus,
the developing cartridge comprising:
a toner;
a developing roller carrying the toner; and
a toner layer thickness control member that is in contact with the developing roller and that regulates a layer thickness of the toner carried on the developing roller and is capable of applying a predetermined voltage; wherein
the toner is a positive-charging toner having a positive-charging property and
the developing roller is the developing roller according to claim 1.

7. The developing cartridge according to claim 6, wherein
the toner comprises a toner particle and an external additive, and
the external additive comprises an inorganic fine particle having an amino group at the surface.

8. A process cartridge comprising:
a developing cartridge; and
an image-bearing member to which a toner is supplied from the developing cartridge to form a toner image; wherein
the process cartridge is the process cartridge according to claim 6.

9. A process cartridge according to claim 8, wherein
the toner comprises a toner particle and an external additive, and
the external additive comprises an inorganic fine particle having an amino group at the surface.

10. An electrophotographic image forming apparatus that forms an image on a recording sheet, comprising:
the process cartridge according to claim 8;
an exposure device that exposes the image-bearing member which the process cartridge has to light to form an electrostatic latent image on the image-bearing member; a transfer device that transfers the toner image formed on the image-bearing member which the process cartridge has onto the recording sheet; and a fixing device that fixes the toner image transferred on the recording sheet onto the recording sheet.

11. The electrophotographic image forming apparatus according to claim 10, wherein
the toner comprises a toner particle and an external additive, and
the external additive comprises an inorganic fine particle having an amino group at the surface.

12. An electrophotographic image forming apparatus,
the electrophotographic image forming apparatus comprising:
an image-bearing member;
a toner;
a developing roller carrying the toner;
a toner layer thickness control member that is in contact with the developing roller and that regulates a layer thickness of the toner carried on the developing roller and is capable of applying a predetermined voltage;
an exposure device that exposes the image-bearing member to light to form an electrostatic latent image on the image-bearing member;
a transfer device that transfers the toner image formed on the image-bearing member by a development of the electrostatic latent image onto the recording sheet; wherein
the toner is a positive-charging toner having a positive-charging property and
the developing roller is the developing roller according to claim 1.

13. The electrophotographic image apparatus according to claim 12, wherein
the toner comprises a toner particle and an external additive, and
the external additive comprises an inorganic fine particle having an amino group at the surface.
